(19) United States
(12) Patent Application Publication
(10) Pub. No.: US 2003/0145710 A1
(43) Pub. Date: Aug. 7, 2003

(54) Multi-segmented saw tooth

(76) Inventor: Keith B. Hicks, Hudson (CA)

Correspondence Address: CATERPILLAR INC., 100 N.E. ADAMS STREET, PATENT DEPT., PEORIA, IL, 616296490

(21) Appl. No.: 10/068,323

(22) Filed: Feb. 6, 2002

(51) Int. Cl. B27B 33/02

(52) U.S. Cl. 83/844

(57) ABSTRACT

A saw tooth system having a plurality of tooth segments is provided. A retainer member engages retainer surfaces on each of the tooth segments to form a saw tooth unit. A retainer fastener may further secure the retainer member and tooth segments relative to one another. Locating flanges may be used to more precisely locate the tooth segments relative to each other or to a tooth holder.

### TECHNICAL FIELD

The present invention relates to a saw tooth for a forestry application, and, more particularly, to a saw tooth unit comprising a plurality of tooth segments.

### BACKGROUND

In a forestry application, it is common for trees to be cut down by a work machine using a rotary saw disk having a plurality of replaceable tooth holders, each tooth holder having a replaceable tooth associated therewith. These teeth are subject to severe damage during the course of operation and are frequently replaced at great expense.

An example of a rotary saw disk tooth is disclosed in U.S. Pat. No. 5,644,965, issued Jul. 8, 1997 to Charles D. MacLennan et al. (hereafter referenced as '965). The '965 tooth assembly includes a tooth head having seats for receiving inserts. The inserts are multiple thin plates or multiple wedge-shaped sections attached to the head using dowels and a clamp nut. The head assembly including the tooth head and inserts is the attached to a tooth holder.

The multiple small parts of '965 require a time-consuming and precise assembly, could be easily lost or improperly installed in the debris-filled environment of a forest work site, and would be difficult to install on a horizontally oriented saw disk, as gravity would work against the proper placement of the dowels and inserts. '965 discusses the desirability to rotate the tooth or replace the inserts so that a fresh cutting surface is presented as needed, but the multiple small parts and precise, complex assembly of '965 would seem to discourage the operator from refreshing the cutting surface.

The present invention is directed to overcoming one or more of the problems as set forth above by providing a method and apparatus of a multi-segmented saw tooth which: includes a minimal number of components and has cutting edges that may be more easily and less expensively repaired than known rotary saw teeth.

### SUMMARY OF THE INVENTION

In an embodiment of the present invention, a saw tooth system is provided. The saw tooth system includes a plurality of tooth segments and a retainer member. Each tooth segment has a retainer surface, and the retainer member is adapted to form a mating relationship with the retainer surface of each tooth segment to form a saw tooth unit.

In an embodiment of the present invention, a tooth segment for a multi-segmented saw tooth is provided. The tooth segment includes at least one cutting tip, one or more cutting edges or portions thereof located adjacent the cutting tip, and a retainer surface.

In an embodiment of the present invention, a method for replacing or repositioning a desired tooth segment in a multi-segmented saw tooth is provided. The saw tooth has two or more tooth segments each having a retainer surface, a retainer member engaging each retainer surface, and a retainer fastener. The method includes the steps of disengaging the retainer member from the retainer surface of the desired tooth segment, and engaging the retainer member with the retainer surface of a replacement tooth segment.

In an embodiment of the present invention, a saw tooth and holder system is provided. The system includes two or more tooth segments having a retainer surface, at least one retainer member, at least one tooth holder, and at least one retainer fastener. The retainer member is adapted to contact each retainer surface. The tooth holder is adapted to contact at least one tooth segment. The retainer fastener is adapted to hold the at least one tooth segment in a contacting relationship with the tooth holder.

### BRIEF DESCRIPTION OF THE DRAWING

For a better understanding of the invention, reference may be made to the accompanying drawings in which:

FIG. 1a is a perspective view of a tooth segment of an embodiment of the present invention;

FIG. 1b is a perspective view, taken from the opposite direction as FIG. 1a, of a tooth segment of an embodiment of the present invention;

FIG. 2a is a perspective view of a saw tooth system of an embodiment of the present invention;

FIG. 2b is a perspective cutaway view, taken along line b-b of FIG. 2a, of a saw tooth system of an embodiment of the present invention;

FIG. 3a is a side cutaway view of a saw tooth of an embodiment of the present invention;

FIG. 3b is a side cutaway view of a saw tooth of an embodiment of the present invention; and

FIG. 3c is a side cutaway view of a saw tooth of an embodiment of the present invention.

### DETAILED DESCRIPTION

An embodiment of the present invention provides an apparatus and method of a multi-segmented saw tooth. The application described assumes a rotary saw disk with a plurality of tooth holders 210, each tooth holder 210 having a saw tooth unit 202 associated therewith.

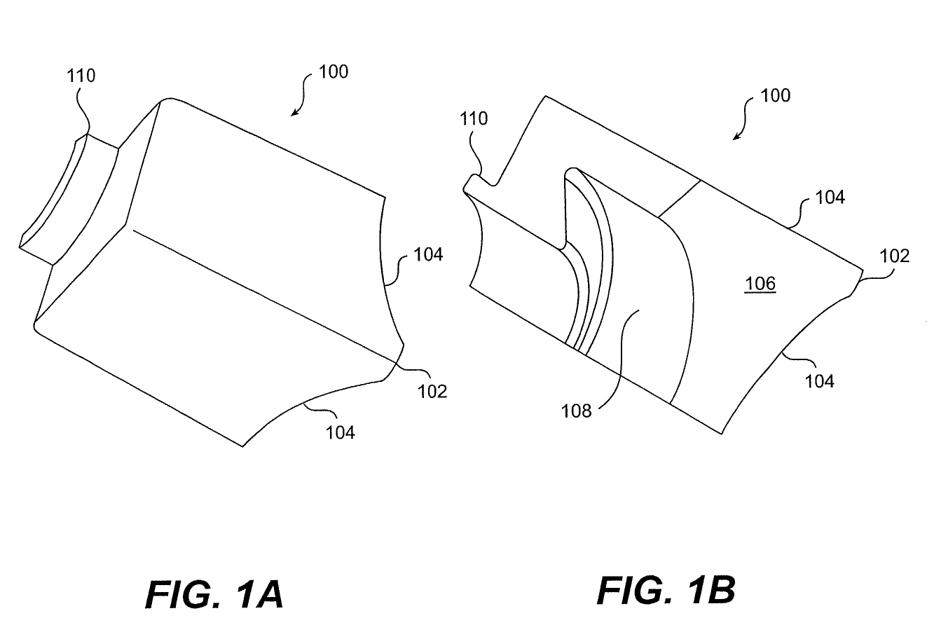

FIGS. 1a and 1b depict two views of a tooth segment 100 according to the present invention. The tooth segment 100 includes at least one cutting tip 102, at least one cutting edge 104 located adjacent the cutting tip 102, a tooth face 106, and a retainer surface 108 of any of a myriad of shapes and cross-sections including circular, square, rectangular, hexagonal, star-shaped, etc. Optionally, the tooth segment 100 may include a locating flange 110, preferably spaced apart from the tooth face 106.

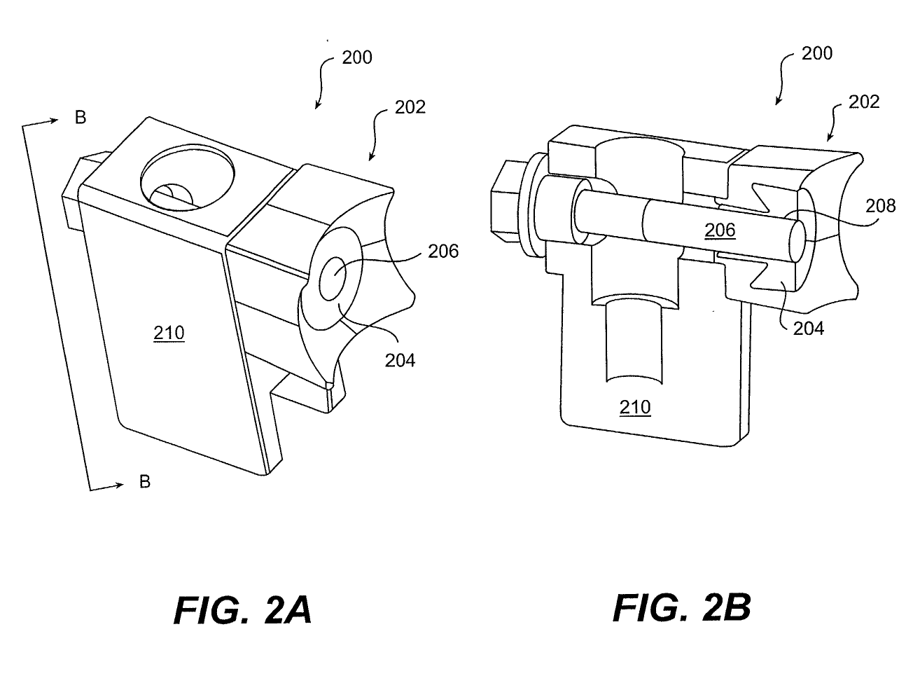

FIGS. 2a and 2b depict a saw tooth system 200 according to the present invention in relation to a tooth holder 210 of a known type. The saw tooth system 200 includes a plurality of tooth segments 100 of any of a myriad of shapes and cross-sections and combinations thereof as desirable. The present invention is shown in this application as including four tooth segments 100. However, it is obvious that any number of tooth segments 100 could each represent a fractional portion of a saw tooth unit 202. The (assembled) saw tooth unit could be cylindrical, cubical, oblong, or any other suitable shape. Also, this invention is not limited to the use of identical or symmetrical tooth segments 100 when making up the saw tooth unit 202.

In addition to the tooth segments 100, FIG. 2a depicts the retainer member 204 and a retainer fastener 206. The tooth segments 100 and the retainer member 204 taken together form the saw tooth unit 202. The exact configuration of the retainer member 204 is not essential to the present invention; the retainer member 204 merely must be of a form to hold the tooth segments 100 in relation, preferably contacting, to the tooth holder 210, either fixedly or to allow movement, for example, rotation, of the tooth segments 100. The retainer member 204 will preferably contact the retainer surface 108 of each tooth segment 100 in the course of securing the tooth segments 100 to the tooth holder 210. The retainer fastener 206 is preferably, but not necessarily, used to further secure the engagement of the retainer member 204 and the retainer surfaces 108. It would also be possible for the retainer member 204 and retainer fastener 206 to be combined into one retainer element which could engage the tooth segments 100, and such an embodiment would be anticipated by the claims of the present invention. This engagement could be accomplished from either the same or a reverse direction as that shown for the retainer member 204 in FIGS. 2a and 2b.

FIG. 2b, a cutaway view of the saw tooth system 200 of FIG. 2a, further illustrates the relative relationship between the components of the present invention. In this embodiment, the retainer member 204 is shown as having a substantially cylindrical cross-section with a tapered end to engage the retainer surfaces 108. The retainer fastener 206 is shown here as a bolt; it should be intuitively obvious that the cylindrical configuration and center cavity 208 of the retainer member 204 allows the retainer fastener 206 to threadably engage the retainer member 204 in a secure yet removable manner, but that the exact method of engagement is not essential to the present invention. The retainer member 204 may rotate relative to the tooth segments 100, should such rotation be advantageous to the assembly of the saw tooth unit 202. The center cavity 208 need not extend completely through the retainer member 204 to fulfill the requirements of the present invention.

FIG. 2b also depicts the relationship of the tooth segments 100, the retainer member 204, and the retainer fastener 206 to the tooth holder 210. The tooth holder 210 is common in the art and need not be limited to the embodiment shown in FIGS. 2a and 2b, but may be of any type available and suitable for the present invention. In FIG. 2b, the retainer fastener 206 extends substantially through the tooth holder 210 to removably attach the saw tooth unit 202 to the tooth holder 210.

A locating flange 110, as shown in FIGS. 1a and 1b, may be used to position each tooth segment 100 relative to another tooth segment 100 and/or relative to the tooth holder 210. By locating flange 110, what is meant is any suitable protrusion or cavity for this purpose; for example, each tooth segment 100 may dovetail into the edge of another tooth segment 100, the tooth segments 100 may include a tab and slot locating system, or the like. The locating flange 110 optionally facilitates the assembly of the saw tooth system 200 and may assist a force transfer from the tooth segments 100 to the tooth holder 210 during use to avoid damage of the tooth segments 100.

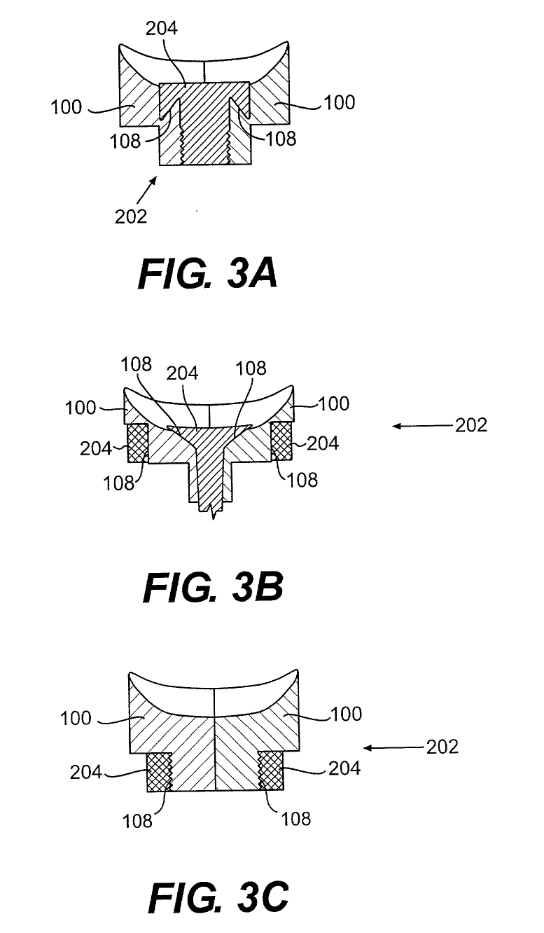

FIGS. 3a, 3b, and 3c each depict possible embodiments of the present invention. In FIG. 3a, a cutaway view is given of the saw tooth unit 202 as shown in the previous Figs. FIG. 3b discloses a saw tooth unit having two retainer members 204—one being a collar-like member and the other being a tapered seated member, the tooth segments 100 being located between the two members. FIG. 3c shows a single collar-like retainer member 204 into which tooth segments 100 are inserted and which holds together the tooth segments 100. FIGS. 3a, 3b, and 3c are intended to show just a few examples of the myriad of combinations of retainer surface 108 shapes, retainer member 204 shapes, tooth segment 100 shapes, attachment methods, and the like which make up the saw tooth unit 202 of the present invention, and should not be taken in such a way as to limit the claims herein.

Optionally, one or more dummy tooth segments (not shown) may be provided for use in the saw tooth unit 202. As is well-known in the art, only a portion of the total cutting tips 102 and/or cutting edges 104 of a saw tooth unit 202 actually do the cutting during operation of the rotary disk saw. Therefore, the dummy tooth segments may be used as a less expensive and/or more available alternative to a sharp or new tooth segment 100 in a non-cutting position, while still keeping the configuration and relative spacing of the tooth segments 100 of the saw tooth unit 202 as desired. These dummy tooth segments may be used/worn tooth segments 100, blank “placeholding” segments, or the like. A double-wide one-piece dummy segment could be used to replace two tooth segments 100 in non-cutting positions of the saw tooth unit 202, for example.

While aspects of the present invention have been particularly shown and described with reference to the preferred embodiment above, it will be understood by those skilled in the art that various additional embodiments may be contemplated without departing from the spirit and scope of the present invention. However, a device or method incorporating such an embodiment should be understood to fall within the scope of the present invention as determined based upon the claims below and any equivalents thereof.

Industrial Applicability

In use, the saw tooth system 200 of the present invention will cut substantially the same way as a traditional one-piece tooth and separate holder. The multi-segmented tooth of the present invention allows an operator to simply replace or reposition one or more tooth segments 100 at will or as the tooth segments 100 wear, with great efficiency and economy.

The saw tooth unit 202 is intended for use much as the traditional one-piece tooth. The saw tooth unit 202 is attached to a tooth holder 210 and may be used in place of or interchangeably with a one-piece tooth with no modification to the tooth holder 210 or attachment mechanism.

The embodiments shown in FIGS. 3a, 3b, and 3c could each be attached to a tooth holder 210 in a secure manner through the use of collars, shaped tooth holders 210, fasteners of any type and location, additional or differently shaped holes/slots/faces than those shown, or any other suitable manner, whether currently used or unknown in the art. It is merely intended that the saw tooth unit 202 contact the tooth holder 210 without the necessary use of an intermediary socket or mounting member, thus providing the minimal number of simple parts and ease of assembly which are advantageous in the field.

In order to position a fresh cutting surface as desired, the operator disengages the retainer member 204 from the retainer surfaces 108 of the tooth segments 100 which make up the saw tooth unit 202. The operator may first need to disengage the retainer fastener 206, if there is one, from the retainer member 204. The operator then either rearranges the tooth segments 100 to place a fresh cutting tip 102 and/or cutting edge 104 at the desired position, or removes one or more of the worn tooth segments 100 and replaces them with new tooth segments 100. A locating flange 110 would be helpful in this rearrangement, but is not necessary. The worn tooth segments 100 may be resharpened for future use, discarded, or saved for use as dummy segments. Should the operator use dummy segments, either purpose-made dummies or reused worn tooth segments 100, the dummy segments would be located in a non-cutting position.

Once the desired combination of dummy segments and fresh tooth segments 100 is achieved, the operator then reengages the retainer surfaces 108 with the retainer member 204. Should the saw tooth system 200 include a retainer fastener 206, the retainer fastener 206 is reengaged. The saw tooth system 200 is then ready for use with fresh cutting surfaces presented.

Due to the efficient design of the present invention, the replacement process as described above can be performed in the field using commonly available tools and a minimal and small number (as few as zero, in the case of a repositioning) of replacement parts. The saw tooth system 200 is also extremely simple to service in the field, even when installed on the saw disk.

It should be understood that while a preferred embodiment is described in connection with a forestry application, the present invention is readily adaptable to provide similar functions in other applications. Other aspects, objects, and advantages of the present invention can be obtained from a study of the drawings, the disclosure, and the appended claims.

What is claimed is:

1. A saw tooth system, comprising:
a plurality of tooth segments, each tooth segment having a retainer surface; and
a retainer member adapted to form a mating relationship with the retainer surface of each tooth segment to form a saw tooth unit.

2. The saw tooth system of claim 1, further including a retainer fastener adapted to engage and secure the saw tooth unit.

3. The saw tooth system of claim 2, wherein the retainer fastener is a bolt and the retainer member includes a bore which is threadably engaged by the bolt.

4. The saw tooth system of claim 2, wherein the retainer member has a cylindrical cross section and may be rotated relative to each tooth segment during the engagement of the retainer member and the retainer fastener.

5. The saw tooth system of claim 2, wherein the retainer member and retainer fastener comprise a retainer unit.

6. The saw tooth system of claim 1, further including a tooth holder, the tooth holder engaging the saw tooth unit.

7. The saw tooth system of claim 2, further including a tooth holder wherein the retainer fastener removably attaches the plurality of tooth segments and the retainer member to the tooth holder.

8. The saw tooth system of claim 6, wherein each tooth segment contacts the tooth holder.

9. The saw tooth system of claim 1, wherein one or more of the tooth segments is a dummy segment.

10. A tooth segment for a multi-segmented saw tooth, the tooth segment comprising:
at least one cutting tip;
one or more cutting edges or portions thereof located adjacent the cutting tip; and
a retainer surface.

11. The tooth segment of claim 10, further including a tooth face located adjacent the cutting tip and one or more cutting edges, and a locating flange at a location spaced from the tooth face.

12. The tooth segment of claim 10, wherein the retainer surface is shaped to receive a retainer member in a contacting relationship.

13. The tooth segment of claim 10, further including a locating flange, wherein the locating flange is adapted to contact at least one of a tooth holder and a second tooth segment in order to locate the tooth segment relative to the at least one of the tooth holder and the second tooth segment.

14. The tooth segment of claim 13, wherein the retainer member brings the tooth segment into contact with the at least one of the tooth holder and the second tooth segment.

15. A method for replacing or repositioning a desired tooth segment in a multi-segmented saw tooth having two or more tooth segments each having a retainer surface, a retainer member engaging each retainer surface, and a retainer fastener, the method comprising the steps of:
disengaging the retainer member from the retainer surface of the desired tooth segment; and
engaging the retainer member with the retainer surface of a replacement tooth segment.

16. The method of claim 15, further including the steps of:
disengaging the retainer fastener and the retainer member; and
reengaging the retainer fastener and the retainer member.

17. The method of claim 15, further including the step of:
engaging the retainer member with the retainer surface of a dummy tooth segment.

18. The method of claim 15, further including the steps of:
disengaging the retainer member from the retainer surface of a second desired tooth segment;
repositioning the desired tooth segment and the second desired tooth segment with respect to the retainer member; and
engaging the retainer member with the retainer surface of the repositioned desired tooth segment and second desired tooth segment.

19. The method of claim 15, further including the step of:
providing a one-piece retainer unit performing the same function as does the combination of the retainer member and retainer fastener.

20. A saw tooth and holder system, comprising:
two or more tooth segments having a retainer surface;
at least one retainer member adapted to contact each retainer surface;
at least one tooth holder adapted to contact at least one tooth segment; and
at least one retainer fastener adapted to hold the at least one tooth segment in a contacting relationship with the tooth holder.
